(19) United States
(12) Patent Application Publication
(10) Pub. No.: US 2011/0240472 A1
(43) Pub. Date: Oct. 6, 2011

(54) CAPACITIVE DEIONIZATION CELL WITH THROUGH-FLOW

(75) Inventors: Leonard Paul Seed, Guelph (CA); Iurie Pargaru, Guelph (CA); Gene Sidney Shelp, Guelph (CA)

(73) Assignee: ENPAR TECHNOLOGIES INC., Guelph, ON (CA)

(21) Appl. No.: 13/139,317

(22) PCT Filed: Dec. 15, 2009
(86) PCT No.: PCT/CA2009/001826

§ 371 Date: Jun. 13, 2011

(30) Foreign Application Priority Data
Dec. 15, 2008 (GB) 0822816.5

(51) Int. Cl. C02F 1/46; C02F 103/08

(52) U.S. Cl. 204/554; 204/674; 204/672

(57) ABSTRACT

The electrodes of the described CDI cell are porous and permeable. The liquid to be deionized (e.g. salt water to be desalinated) flows through the electrodes. The electrodes are arranged in a stack, alternating anode/cathode, and water being treated passes through every electrode in the whole stack. For regeneration, the cells are connected (short-circuited) together, and the ions are dislodged mainly by flushing action. The through-flow arrangement can be realized in a number of different configurations.

This technology relates to the removal of dissolved contaminants from a liquid, and will be described as it particularly relates to the desalination of salt water.

### BACKGROUND TO THE INVENTION

It is known to desalinate salt water by Capacitive Deionization (CDI) (also sometimes known as Electrostatic Deionization). The process basically consists in passing the saltwater between a pair of electrodes, each of large surface area, between which a DC voltage is applied. Positive ions (e.g. Na+ ions) migrate to the cathode, and negative ions (e.g. Cl− ions) migrate to the anode. The adsorbed ions are then bound to the respective electrodes. From time to time, the stored ions are removed from the electrodes by an appropriate regeneration process.

Typically, in the conventional CDI cells, the electrodes are in the form of flat plates or sheets of e.g. activated carbon. Salt water flows along the space between the plates, the ions being attracted to the appropriate electrode by electrostatic forces. Thus, the ions are adsorbed onto the respective electrodes from the passing water.

A conventional CDI-based treatment apparatus generally includes several of the cells, arranged in a stack of cells, and includes suitable structure for mounting the electrodes of the individual CDI cells, and for conveying the water into and through the spaces between the electrodes.

Ions are adsorbed into the porous material of the electrodes, and are retained and stored therein, whereby the effluent water from the CDI cell is less salty than the influent water.

For regeneration, usually the flow of salt water undergoing treatment is switched off, or re-routed, and a flow of regeneration water is now passed through the CDI cell. (In some cases, the regeneration water can be the same salt water.) Traditionally, the polarity of the cells is reversed, whereby the adsorbed ions are repelled from the electrodes, and enter the regeneration water. Typically, regeneration is carried out a few times per hour, and the regeneration process is typically completed in a few minutes. The treatment/regeneration cycle preferably should be automated.

The salt content of the effluent regeneration water is usually considerably higher than (e.g. ten times) that of the salt water being desalinated. Where the salt water is drawn from the sea, the high-salt regen-water is simply discharged into the sea. If disposal in the sea is not available, further treatment of the concentrate stream might be required; however, the volume of the concentrate is typically only about five percent of the treated water stream.

Conventional CDI cells may or may not be provided with charge-barriers, which are ion-permeable membranes that are impervious to water, and placed over one or both of the electrodes. Charge barriers are aimed at preventing contamination of the electrode pore volume with the source water and to prevent re-adsorption of the ions during regeneration.

### THE INVENTION IN RELATION TO THE PRIOR ART

In the traditional CDI cells, the liquid to be deionized flows through the cell, through the space between the anode and the cathode, in a direction parallel to the plane of the electrodes. This arrangement may be described as the traditional flow-by configuration.

In the new CDI treatment systems as described herein, the water passes through the electrodes themselves. The water passes through the space between the electrodes in the direction predominantly at right angles to the plane of the electrodes. That is to say, the velocity vector of the water has a predominant component that lies at right angles to the plane of the electrodes. This arrangement may be described as the through-flow configuration.

The electrode being in the form of a thin sheet of porous material, the sheet having opposed sides, the liquid (e.g. salt water) to be deionized flows right though the pores of the electrode, from the upstream side to the downstream side. Therefore, in the present technology, the electrode must have a sufficient degree of permeability to permit the desired through-flow of water.

One benefit of the through-flow configuration is that the anodes and cathodes can be comparatively much closer together. In the traditional flow-by configuration for CDI cells, the space between the electrodes has to be large enough for the water to flow parallel to the plane of the electrodes. The closer spacing of the electrodes permitted in the new through-flow configuration means a stronger electrostatic field for a given voltage.

Since they are generally impermeable, charge-barriers are contra-indicated for use with through-flow electrodes. However, the problem that charge barriers are aimed at curing, i.e. to prevent re-adsorption of the ions during regeneration is less significant when the water passes through anode, then cathode, then anode, then cathode, many times. The omission of charge barriers is advantageous from the cost and complexity standpoint.

### DETAILED DESCRIPTION OF PREFERRED EMBODIMENTS

The technology will now be further described with reference to the accompanying drawings, in which:

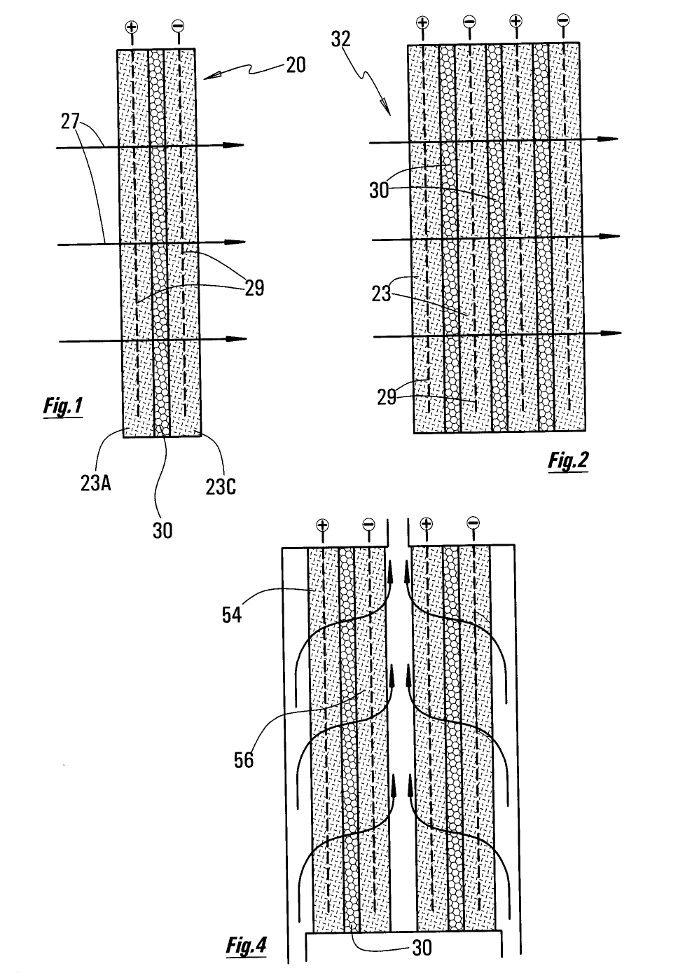

FIG. 1 is diagram of a two-electrode CDI cell, in which the flow of to-be-treated salt water through the cell is arranged in the through-flow configuration.

FIG. 2 is a similar diagram of a stack of electrodes, arranged in the through-flow configuration.

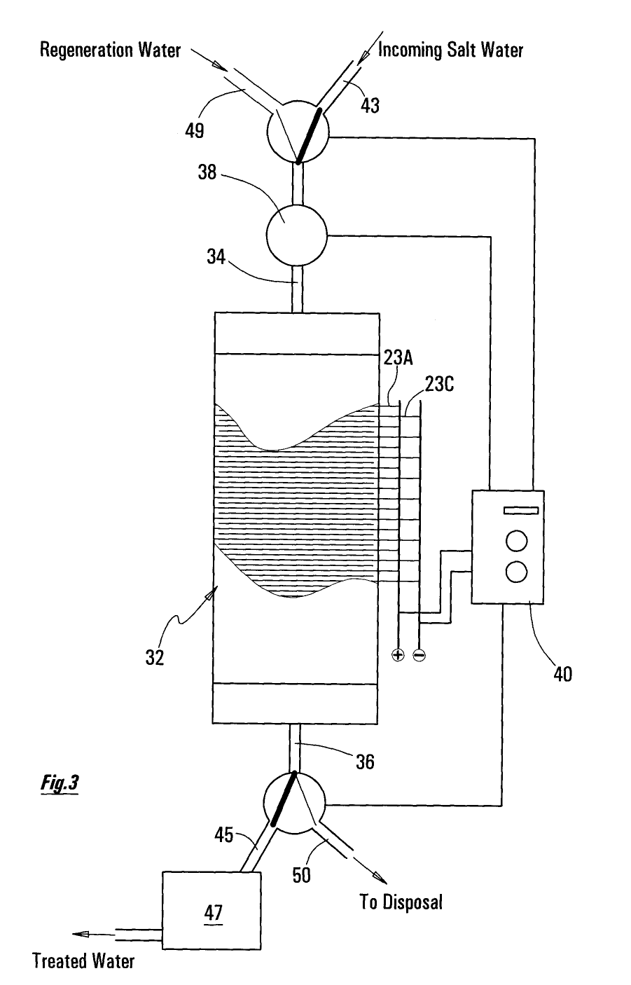

FIG. 3 is a diagram showing the arrangement of some of the components of the apparatus associated with the stack of FIG. 2.

FIG. 4 is a diagram, similar to FIG. 1, showing another arrangement of CDI cells having the through-flow configuration.

The scope of the patent protection sought herein is defined by the accompanying claims. The apparatuses and procedures shown in the accompanying drawings and described herein are examples.

FIG. 1 shows a single CDI cell 20. A DC voltage of (typically) 1.3 volts is supplied to the electrodes 23A,23C, whereby 23A is an anode and 23C is a cathode. Water to be desalinated is passed through the cell 20 from left to right, as indicated by the arrows 27.

The electrodes 23 are made of a high-surface-area porous material, such as activated carbon. The electrodes 23 are prepared from carbon in the form of flat sheet of a constant thickness; in the example, the thickness is 0.5 millimetres. Also, in the example, the electrode is 5,000 square centimetres (0.5 sq.metres) in area.

The electrode 23 contains a mesh structure 29, or grid of wires, which is attached to (or embedded in) the carbon material. The wires are of titanium, or other material that is substantially inert in saltwater. The grid serves the dual purposes of providing mechanical support for the carbon material and for even distribution of current, and of smoothing out any voltage differences and gradients that might otherwise be present in the electrode 23—activated carbon being not so conductive, electrically, as titanium.

The electrodes 23A,23C are identical as to structure. The electrodes are held apart by an electrode spacer 30, sufficiently that the anode and cathode cannot touch each other and thereby make an electrical short circuit. The spacer 30 is made of a suitably-inert plastic, which is structured to hold the electrodes apart, substantially without inhibiting the through-flow of water through the cell. In the example, the spacer 30 is of an open-weave structure.

As shown in FIG. 2, a number of the cells 20 may be arranged as a stack 32 of cells; or rather, the electrodes 23 may be arranged as a stack of electrodes. In FIG. 2, the electrodes 23 and the spacers 30 are so arranged as to form an intercalated, anode-spacer-cathode-spacer-anode-spacer-cathode-spacer-etc, configuration. In the example, all the odd-numbered electrodes in the stack are connected together electrically and are so charged as to become anodes, while all the even-numbered electrodes are connected together and so charged as to become cathodes. Alternatively, pairs of electrodes can be connected electrically in series. In the example, the stack includes a hundred anodes 23A, a hundred cathodes 23C, and a hundred-ninety-nine spacers 30.

In FIG. 2, salt water to be treated is fed into the stack at a water-inlet-port 34, located to the left. Treated water, having passed through the stack 32 of electrodes, is discharged through a water-outlet-port 36, located to the right.

The electrodes 23, though very porous, nevertheless have a relatively low permeability to the through-flow of water (i.e. a low ability to conduct through-flow)—to the extent that a considerable hydraulic pressure is required (from e.g. a pump 38—see FIG. 3) in order to force the water through the stack 32 of electrodes 23 and spacers 30.

The designers would typically aim for the stack 32 as a whole to be of such resistance to the desired magnitude of flowrate that the pressure head between the inlet-port 34 and the outlet-port 36 is between about five pounds/sq.inch (thirty-five kN/m2) per hundred electrodes in the stack and about thirty psi. Below about five psi per hundred electrodes, the water will pass through the electrodes too quickly, whereby the residence time per electrode would be too short for adequate and efficient removal of the ions. Above about thirty psi, the energy needed to pump the water through the stack makes the process start to become uneconomic.

Thus, in FIG. 2, where there are two hundred electrodes 23, the designer should so arrange the permeabilities of the electrodes 23 that the overall pressure drop through the stack, at the desired flowrate, is between about ten psi and sixty psi.

It is assumed, in the above, that the electrode-spacers 30, by contrast, offer only a negligible resistance to the flow of water through the stack. If the spacers 30 do have significant resistance, the pump pressure would be increased accordingly.

The considerations re hydraulic pressure above apply during treatment. Other factors apply during regeneration. Especially during regeneration, it can be advantageous to use suction to aid the flow of regeneration water through the electrode stack.

The cells as described are effective to lower the salination percentage of water passing through the cell over the whole range of salination, from seawater having about four percent (40,000 ppm) salt, through brackish water at about one percent salt, to almost-pure water. Thus, the treatment system can be tuned to a particular salt-removal requirement simply by adding or removing electrodes to or from the stack. The water should be passed through the electrodes in the stack one after the other; that is to say, the water being treated is routed through the CDI cells on an in-series-flow basis.

The ability of the described system simply to use more or fewer of the same components to cater for a variety of treatment conditions can also be understood in relation to changing the magnitude of the liquid flow. Of course, if more water needs to be treated, extra facilities are required. However, this need not be a matter of adding further whole, separate, systems. Rather, the designers can often effect economic savings, when the use of several stack units is contemplated, by arranging the stack units in parallel from the standpoint of dividing and treating the liquid flow, and in series from the standpoint of electrical energization.

It will be understood that, in FIG. 2, every pair of adjacent electrodes in the stack can be regarded as an individual CDI cell, irrespective of whether the salt water engages the pair anode-first or cathode-first. Preferably, but not essentially, the number of anodes should exactly equal the number of cathodes, or rather, preferably the effective aggregate area of all the cathodes should equal the effective aggregate area of all the anodes.

FIG. 3 shows the control system for operating the apparatus, diagrammatically. The apparatus is capable of being operated in the treatment condition, or in the regeneration condition. The controller 40 is set up so as to cycle between the two conditions. In the treatment condition, salt water requiring desalination is routed (via pipe 43) to the inlet-port 34, and the treated water from the outlet-port 36 is conveyed away (via pipe 45) to a storage tank 47.

In the regeneration condition, the controller connects (shorts) all the electrodes 23 together, so that all are at the same voltage. Regeneration water is now passed through the stack. The regeneration water is routed (via pipe 49) into the inlet-port 34. The ions, now released from the electrodes, are picked up by and in the regeneration water, and conveyed out of the outlet-port 36. The regeneration water is then routed for disposal (via pipe 50).

The controller is arranged to operate cyclically between the treatment and regeneration conditions. The period of time for treatment, per cycle, is TT. The period for regeneration is TR. In the example, TT is five minutes, and TR is two minutes. The designers wish to keep TR as short as possible, and they wish to use as little regeneration water as possible, since both the time and the water represent inefficiencies in the overall operation of the apparatus.

Generally, the designers will wish to optimize the design of the components of the stack from the standpoint of operating efficiency during the treatment part of the cycle, and will usually arrange for the water to be fully treated in just one pass through the stack. That being so, during regeneration, it might be necessary for the regeneration water to be circulated and recirculated through the stack, for the most cost-effective compromise between effective regeneration of the electrodes versus the amount of regeneration water required and the time TR. Also, in some cases, the designers might wish to employ recirculation of the salt water during the treatment period.

As mentioned, for regeneration of the through-flow CDI cells and electrodes as described herein, the electrodes are all connected, i.e. shorted, together. This may be contrasted with regeneration in a traditional CDI cell with charge-barriers, where the flow of water is parallel to the electrode. In that traditional case, the designers arrange for the polarity of the electrodes to be reversed, during regeneration, so that the ions that have been adsorbed into the electrodes are positively repelled, electrostatically, out into the stream of regeneration water. In the traditional cell, if the electrodes were simply shorted, with no repulsive component, the ions would only enter the regeneration water stream by diffusion, which would be very inefficient.

However, in the case of a traditional CDI cell without charge barriers, by contrast, the practice has been to short the electrodes together during regeneration, and that practice is followed in the systems described herein.

In the present case, the adsorbed ions are positively flushed out of the pores of their home electrode by the physical velocity of the regeneration water passing through those same pores. In fact, with the through-flow configuration, it would be disadvantageous to reverse the polarity of the electrodes—in that, although the ions might be repelled, electrostatically, from their home electrode, they would be quickly re-adsorbed into the adjacent electrode. In the through-flow configuration, the ions have to travel right through the stack, or rather, they have to travel through all the porous electrodes between their home electrode and the outlet. Thus, through-flow regeneration can be expected to be more efficient than traditional parallel-flow regeneration, just as through-flow treatment can be expected to be more efficient than traditional parallel-flow treatment.

Other arrangements of the electrodes are possible, using the through-flow configuration. FIG. 4 is a version in which the velocity vector of the incoming salt water at first is parallel to the upstream electrode 54, but then the vector assumes a component at right angles to the electrode, and the flow passes through the electrode-spacer 30 in that direction. As the cleaned water emerges from the downstream electrode 56, its vector once again becomes parallel to the electrodes. The cleaned water passes out between the two electrodes.

In this specification, some of the components and features in the drawings are given numerals with letter suffixes, to indicate anode, cathode, etc, versions thereof. The numeral without the suffix is used herein to indicate the component generically.

The numerals that appear in the accompanying drawings can be summarized as:—
20 CDI cell
23 electrode
23A anode
23C cathode
27 flow path arrow
29 wire mesh current collector
30 electrode spacer
32 stack of electrodes
34 water inlet port
36 water outlet port
38 water pump
40 controller
43 pipe—salt water in
45 pipe—treated water out
47 storage tank
49 pipe—regen water in
50 pipe—regen water out
54 upstream electrode
56 downstream electrode

1. Liquid treatment apparatus, which includes a flow-through electrochemical cell, wherein:—
the flow-through cell includes first and second electrodes, which are so arranged and supplied with electricity as to form one a cathode and the other an anode;
in respect of each electrode:—
the material of the electrode is porous;
the material is permeable with respect to a substantial rate of flow of liquid passing through the pores of the material;
the electrode is in the form of a thin sheet;
the flow-through cell includes an electrode-spacer, which is so structured and arranged as:—
to prevent the electrodes from making an electrical short-circuit; and
to enable the said substantial flow of liquid to pass from the first electrode to the second electrode;
the apparatus is so structured and arranged as to convey the substantial flow of liquid through the flow-through cell, being through the first electrode and then through the second electrode.

2. As in claim 1, wherein the cell is so arranged as to form a capacitive deionization (CDI) cell, and to adsorb ions dissolved in the liquid onto the electrodes.

3. As in claim 1, wherein:
the electrodes are arranged in a parallel face-to-face relationship;
one side of the thin sheet of the first electrode is termed the upstream side of the first electrode, the opposite side being termed the downstream side of the first electrode;
one side of the thin sheet of the second electrode is termed the upstream side of the second electrode, the opposite side being termed the downstream side of the second electrode;
the electrodes are arranged, in the apparatus, with the downstream side of the first electrode facing the upstream side of the second electrode.

4. Liquid treatment apparatus, which includes a stack of flow-through electrodes;
the electrodes in the stack are so supplied with electricity that some of the electrodes are anodes, and some others are cathodes;
in respect of each electrode:—
the material of the electrode is porous;
the material is permeable with respect to a substantial rate of flow of liquid passing through the pores of the material;
the electrode is in the form of a thin sheet;
the stack of electrodes is so arranged that a substantial flow stream of liquid can pass through the stack, through from a first end electrode of the stack, through the anodes and cathodes, to the opposite end electrode;
the apparatus includes a liquid-inlet-port, which is so structured as to accept liquid to be treated into the apparatus, and to convey the accepted liquid to the upstream side of the first end electrode of the stack;
the apparatus includes a liquid-outlet-port, which is so structured as to collect liquid passing from the downstream side of the opposite end electrode of the stack, and to convey the collected liquid out of the apparatus;
the apparatus includes a liquid-conduit, which is so structured as to convey the substantial flow of liquid through the stack of electrodes, from the liquid-inlet-port to the liquid-outlet-port; and
the stack includes electrode-spacers, which:—
are located between the anodes and cathodes in such manner as to prevent the same from making an electrical short-circuit; and
are permeable to the said substantial flow of liquid passing through the stack.

5. As in claim 4, wherein the electrodes in the stack are arranged in an alternating anode-cathode-anode-cathode, and so on, configuration;

6. As in claim 4, wherein the stack is so arranged that adjacent pairs of the electrodes in the stack form respective capacitive deionization (CDI) cells, to adsorb ions dissolved in the liquid onto the electrodes.

7. As in claim 4, wherein:
the apparatus includes an operable liquid mover, which is effective, when operated, to urge the substantial flow of liquid into and through the water-inlet-port, through the liquid-conduit, and through and out of the water-outlet port;
the liquid mover is capable of maintaining a pressure differential, between the liquid-inlet-port and the liquid outlet-port, of about ten psi (seventy kN/m2) per hundred electrodes in the stack.

8. As in claim 4, wherein:
the electrodes include respective current collectors;
each collector includes a mesh or grid structure, which is attached to, or is embedded in, the porous material of the electrode;
the mesh or grid structure is of titanium, or of another material that is electrically conductive, is physically strong enough to support the electrode, and is substantially inert in saltwater.

9. As in claim 4, wherein:
the pair of electrodes define a face-to-face area of the pair, being the area in which the electrodes are in a physically overlapping face-to-face relationship;
the face-to-face area has a perimeter, being the circumference of the face-to-face area;
the dimension A of the area inside the perimeter is, at least approximately, the same for all the pairs in the stack;
the area A is about 5,000 square centimetres, or more;

10. As in claim 9, wherein the thickness TE cm of the electrode is about one hundredth of the square-root of A, or less.

11. As in claim 1, wherein the flow of liquid relative to the electrodes is characterized as being in a through-flow configuration in that the velocity vector of the moving liquid has a predominant component that lies at right angles to the plane of the electrodes.

12. Procedure for operating an apparatus that falls within the scope of claim 1, including:
providing an electrical controller, which is operable between a treatment condition and a regeneration condition, wherein:—
in its treatment condition, the controller so supplies electricity to the electrodes in the stack that the electrodes have the said anode-cathode-anode-cathode and so on, configuration; and
in its regeneration condition, the controller shorts the electrodes together, to the extent that all the electrodes are at substantially the same voltage;
performing treatment, by operating the electrical controller to its treatment condition, and passing a stream of salt water through the stack of electrodes, for a treatment time period TT;
performing regeneration, by operating the electrical controller to its regeneration condition, and passing a stream of regeneration water through the stack of electrodes, for a regeneration time period TR;
operating the apparatus cyclically between treatment and regeneration, in which period TT is at least two times longer than period TR.
